(19) United States
(12) Patent Application Publication
(10) Pub. No.: US 2012/0072645 A1
(43) Pub. Date: Mar. 22, 2012

(54) NONVOLATILE SEMICONDUCTOR MEMORY

(75) Inventors: Nozomi Kasai, Yokohama-shi (JP); Yoshiharu Hirata, Yokohama-shi (JP)

(73) Assignee: KABUSHIKI KAISHA TOSHIBA, Tokyo (JP)

(21) Appl. No.: 13/049,009

(22) Filed: Mar. 16, 2011

(30) Foreign Application Priority Data
Sep. 17, 2010 (JP) 2010-210003

(51) Int. Cl. G06F 12/02

(52) U.S. Cl. 711/103; 711/E12.008

(57) ABSTRACT

According to one embodiment, a nonvolatile semiconductor memory includes a memory cell array with a block including word lines, and each word line connected to memory cells, a controller which controls a data erase of the memory cells in the block, and a verify circuit which verifies whether or not the data erase is completed. The controller comprises being executed a verification by the verify circuit after being executed a first block erase in a predetermined condition, being executed a second block erase continuously when the number of memory cells which are judged by the verification as a completion of the data erase is n (n is a natural number) or less, and being executed a page erase continuously when the number of memory cells which are judged by the verification as a completion of the data erase is more than n.

### CROSS-REFERENCE TO RELATED APPLICATIONS

This application is based upon and claims the benefit of priority from Japanese Patent Application No. 2010-210003, filed Sep. 17, 2010; the entire contents of which are incorporated herein by reference.

### FIELD

Embodiments described herein relate generally to a nonvolatile semiconductor memory.

### BACKGROUND

A nonvolatile semiconductor memory for storing 2-level data or multi-level data by the internal charge amount of a charge storage layer has the characteristic that the margin between the levels (threshold distributions) gradually narrows due to the repetition of write/erase. The causes are an electron trap in a tunnel oxide film, and an increase in interface state density.

The former occurs when electrons are trapped in a tunnel oxide film due to the repetition of write/erase, and decreases the write/erase rate. The latter reduces a read current, and practically narrows the margin between the levels.

In the nonvolatile semiconductor memory as described above, programming is performed for each page. Also, in one page as a programming target, a selected cell (write-inhibit cell) that maintains an erase state and a selected cell (write-execute cell) that raises the threshold value coexist. Accordingly, the number of times of write/erase changes from one memory cell to another, and this changes the write/erase rate from one memory cell to another. In addition, the write/erase rates of memory cells are sometimes initially different due to, e.g., the manufacturing conditions.

On the other hand, erase is performed for each block. As described above, however, high-erase-rate memory cells and low-erase-rate memory cells coexist in one block. In this case, if control is performed such that the low-erase-rate memory cells fall within a predetermined threshold range, the high-erase-rate memory cells fall outside the predetermined threshold range and are overerased. The overerased memory cells are returned to the predetermined threshold range again by write back. In this case, however, the low-erase-rate memory cells fall outside the predetermined threshold range again.

Accordingly, it is necessary to converge all memory cells in one block to the predetermined threshold range by repeating erase/write back. As a consequence, the erase time prolongs.

### BRIEF DESCRIPTION OF THE DRAWINGS

FIG. 1 shows an embodiment.

FIG. 2 shows a configuration of bank/block/page.

FIG. 3 shows a memory cell array of a NOR type flash memory.

FIG. 4 shows a bit assignment of a 2-level memory.

FIG. 5 shows a bit assignment of a 4-level memory.

FIG. 6 shows an over erase state.

FIG. 7 shows a flow chart of the embodiment.

FIG. 8 shows a flag as a modification example.

FIG. 9 shows a circuit as a modification example.

FIG. 10 shows a state of page erase.

FIG. 11 shows a condition of a modification example.

### DETAILED DESCRIPTION

In general, according to one embodiment, a nonvolatile semiconductor memory comprising: a memory cell array with a block including word lines, and each word line connected to memory cells; a controller which controls a data erase of the memory cells in the block; and a verify circuit which verifies whether or not the data erase is completed, wherein the controller comprises: being executed a verification by the verify circuit after being executed a first block erase in a predetermined condition, being executed a second block erase continuously when the number of memory cells which are judged by the verification as a completion of the data erase is n (n is a natural number) or less, and being executed a page erase continuously when the number of memory cells which are judged by the verification as a completion of the data erase is more than n.

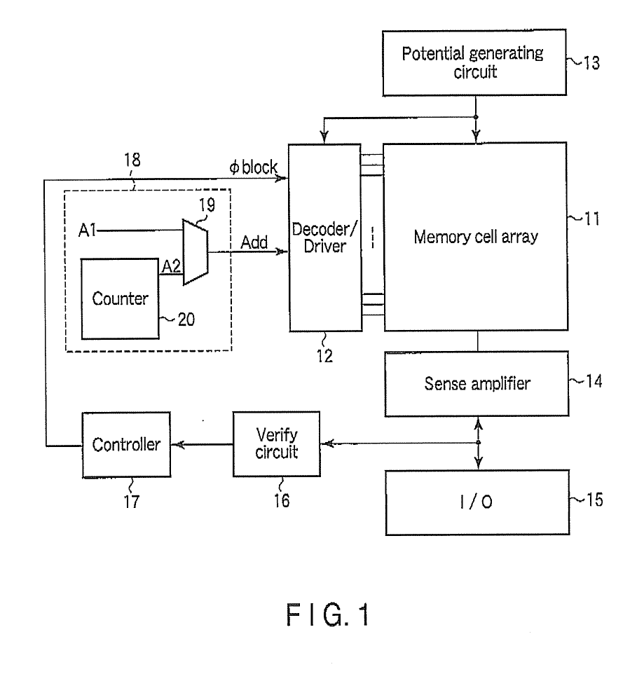

FIG. 1 shows a nonvolatile semiconductor memory of an embodiment.

Memory cell array 11 is of, e.g., a NOR type or NAND type, and includes memory cells each having a charge storage layer. The memory cell stores 2-level data or multi-level data by the internal charge amount of the charge storage layer.

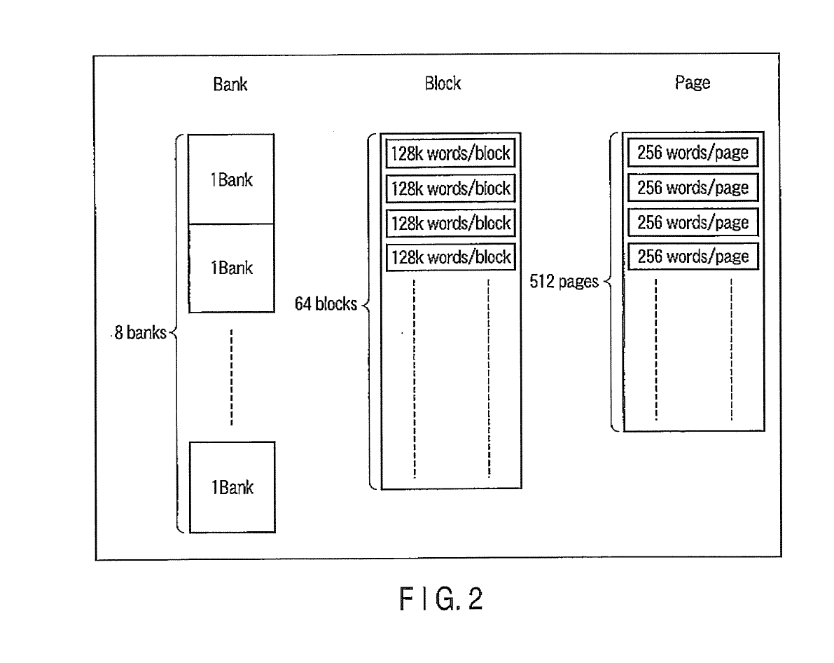

Memory cell array 11 includes banks, blocks, and pages shown in FIG. 2. That is, memory cell array 11 includes banks (in this embodiment, 8 banks). One bank includes blocks (in this embodiment, 64 blocks). One block includes pages (in this embodiment, 512 pages). One page has, e.g., 256 words.

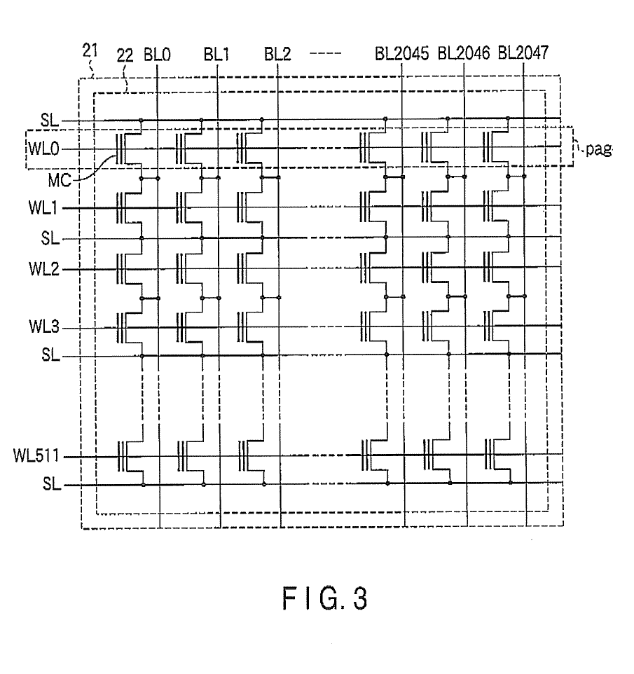

When memory cell array 11 is of a NOR type, an equivalent circuit diagram of memory cell array 11 is as shown in FIG. 3. Referring to FIG. 3, memory cells MC connected to word lines WL0 to WL511 form one block. When memory cell MC stores 2-level data, one page is formed by 2,048 (256-byte) memory cells MC connected to one word line.

Memory cells MC are connected between bit lines BL0 to BL2047 and source lines SL. Also, memory cells MC are arranged in cell p-well (p-type well region) 22 in common cell n-well (n-type well region) 21.

Decoder/driver 12 selects a block and word line in memory cell array 11, and drives word lines in accordance with an operation mode.

In this embodiment, decoder/driver 12 selects one block (selected block) as an erase target in an erase operation, and selects all word lines in the selected block when control signal φ_{block} is “H”. In this state, potential generating circuit 13 applies, e.g., 0 V to cell p-well 22 shown in FIG. 3, and applies erase negative potential (erase potential) −Vera to all the word lines in the selected block via decoder/driver 12.

Also, decoder/driver 12 selects one block (selected block) as an erase target in an erase operation, and selects one word line (selected word line) in the selected block when control signal φ_{block} is “L”. In this state, potential generating circuit 13 applies, e.g., 0 V to cell p-well 22 shown in FIG. 3, applies erase negative potential (erase potential) −Vera to the selected word line in the selected block via decoder/driver 12, and applies, e.g., 0 V to remaining unselected word lines.

Sense amplifier 14 senses read data (including verify read data) from memory cell array 11. I/O 15 functions as an interface circuit for data input/output.

Verify circuit 16 verifies whether write/erase for a memory cell is complete, based on the verify read data. The verify result (pass/fail) is transferred to controller 17.

In an erase operation of this embodiment, controller 17 first executes block erase (provisional erase) whose erase targets are all memory cells in a selected block under a predetermined condition. Based on the verify result of this provisional erase, controller 17 determines whether to perform block erase, or page erase whose erase targets are memory cells in one page (selected page) in the selected block, as erase to be continuously performed.

Also, controller 17 changes control signal φ_{block} to “H” when executing block erase, and changes control signal φ_{block} to “L” when executing page erase.

Page erase means data erase for memory cells connected to one selected word line. When memory cells connected to one word line form one page, page erase means data erase of one page. When memory cells connected to one word line form pages, page erase means data erase of pages.

Address generating circuit 18 includes selector (multiplexer) 19 for selecting external address signal A1 and internal address signal A2, and counter 20 for generating internal address signal A2. Counter 20 is used to increment the internal page address of a selected block one at a time during page erase.

The erase operation of the nonvolatile semiconductor memory shown in FIGS. 1, 2, and 3 will be explained below.

The erase operation is an operation of returning the threshold voltage of a memory cell to the initial state.

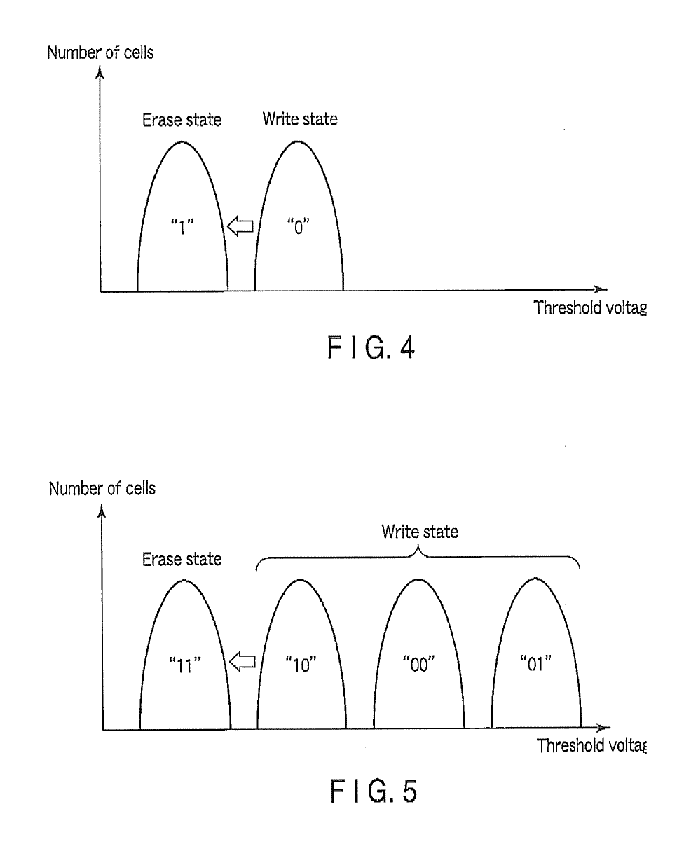

In a 2-level memory as shown in FIG. 4, for example, bit assignment is set at 0 V or more for both “1” (an erase state) and “0” (a write state). In a 4-level memory as shown in FIG. 5, for example, bit assignment is set at 0 V or more for all of “11” (the erase state) and “10”/“00”/“01” (the write state).

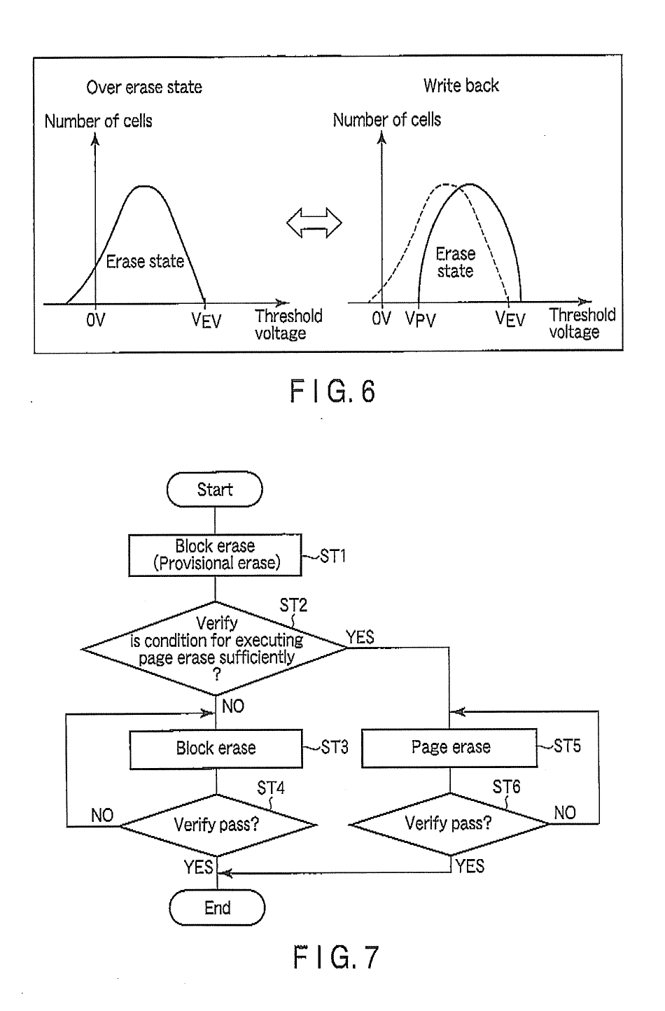

When returning the write state to the erase state by the erase operation in this case, as shown in FIG. 6, an overerase state occurs if control is performed such that the threshold voltages of all memory cells are lower than erase verify potential V_{EV}. Especially in the bit assignments as shown in FIGS. 4 and 5, the threshold voltage of a memory cell having a high erase rate is 0 V or less as shown in FIG. 6.

A memory cell having a threshold voltage of 0 V or less as described above is normally ON, i.e., is ON even when unselected, and hence exerts an adverse effect on a read operation.

Accordingly, a write back operation is generally executed as shown in FIG. 6. The write back operation is write in which the write condition is relaxed, i.e., the threshold fluctuation width is decreased, when compared to normal write from the erase state to the write state. The purpose of the write back operation is to make the threshold voltages of all memory cells higher than write back verify potential V_{PV}.

Since, however, this write back operation is performed for all memory cells in a selected block as an erase target, the threshold voltage of a low-erase-rate memory cell becomes higher than erase verify potential V_{EV} again as shown in FIG. 6.

Accordingly, the erase operation like this requires a long time to converge all memory cells in one block to the predetermined threshold range.

To reduce the number of times of the write back operation or make it unnecessary, therefore, this embodiment proposes an erase operation as shown in FIG. 7.

First, under a predetermined condition, block erase (provisional erase) whose erase targets are all memory cells in a selected block is executed once or more. Then, based on the verify result of this provisional erase, whether to perform block erase, or page erase whose erase targets are memory cells in one page (selected page) in the selected block, as erase to be continuously performed after that, is determined (steps ST1 and ST2).

The condition of provisional erase is one or more of the following conditions.
Letting t1 be a term during which the erase potential is applied to all memory cells in a selected block in the normal erase operation of changing the write state to the erase state, the erase potential is applied to all the memory cells in the selected block for term t2 shorter than t1.
Letting V1 be a voltage to be applied between the cell p-well and the control gates (word lines) of all memory cells in a selected block in the normal erase operation of changing the write state to the erase state, voltage V2 lower than V1 is applied between the cell p-well and the control gates of all the memory cells in the selected block.
Letting V_{EV1} be an erase verify potential to be used in the normal erase operation of changing the write state to the erase state, whether the erase of all memory cells in a selected block is complete/incomplete is verified by using erase verify potential V_{EV2} higher than V_{EV1}.

Note that the normal erase operation condition is used for a case other than those defined by the above-described conditions.

Provisional erase is performed under the above-mentioned conditions, and, if the number of memory cells found to be completely erased after the provisional erase is n (n is a predetermined natural number) or less, the normal erase operation using block erase is performed after that (steps ST3 and ST4).

This is so because the number of low-erase-rate memory cells is small, and hence the probability of the generation of an overerased memory cell is low even when block erase is continuously executed after that.

In this block erase, control signal φ_{block} shown in FIG. 1 changes to “H”. Therefore, erase negative potential (erase potential) −Vera is applied to all the word lines in the selected block as an erase target, and 0 V, for example, is applied to the cell p-well.

Consequently, electrons are extracted to the cell p-well from the charge storage layers of memory cells in the selected block, so the threshold values of the memory cells decrease.

On the other hand, if the number of memory cells found to be completely erased after the provisional erase exceeds n, it is determined that the condition of proceeding to page erase is met, and the normal erase operation using page erase is performed after that (steps ST5 and ST6).

This is so because the number of low-erase-rate memory cells is large, and hence the probability of the generation of an overerased memory cell increases if block erase is continuously executed after that.

In this page erase, control signal φ_{block} shown in FIG. 1 changes to “L”. Therefore, erase negative potential (erase potential) −Vera is applied to one word line (selected word line) in the selected block as an erase target, and 0 V, for example, is applied to remaining unselected word lines and the cell p-well.

Consequently, electrons are extracted to the cell p-well from the charge storage layers of memory cells connected to the selected word line in the selected block, so the threshold values of these memory cells decrease.

The word lines in the selected block are selected one by one in order by, e.g., counter 20 shown in FIG. 1. In the memory cell array shown in FIG. 3, for example, word line WL0 is selected first. Page erase is executed once or more for one page connected to word line WL0. If verify after the page erase is pass, the page erase is immediately terminated, and the process advances to next word line WL1. Thus, page erase is sequentially executed for all word lines WL0 to WL511.

In this embodiment as explained above, block erase (provisional erase) is first performed under the condition easier that that of the normal erase operation, i.e., the condition that the threshold fluctuation width obtained by one erase operation is smaller than that of the normal erase operation, or the condition that the erase verify potential is higher than the normal erase verify potential. In accordance with the result of this provisional erase, the unit (block erase/page erase) of an erase operation to be continuously performed after that is determined.

In the erase operation as described above, it is possible to reduce the number of times of the repetitive operation of erase and write back or eliminate the repetitive operation itself, thereby shortening the erase time. It is also possible to shorten the time during which the voltage stress is applied to a memory cell in the erase operation. This suppresses the characteristic fluctuation (e.g., the delay of erase) of the memory cell.

Furthermore, the erase operation according to this embodiment changes the unit of erase (block erase/page erase) to be performed later, based on the result of initial block erase (provisional erase). This feature largely differs from a conventional nonvolatile semiconductor memory in which, e.g., block erase and page erase are selectively used based on data stored in a register.

This embodiment does not require any register for storing data indicating whether to perform block erase or page erase. This makes it possible to reduce the circuit area or chip size of a nonvolatile semiconductor memory.

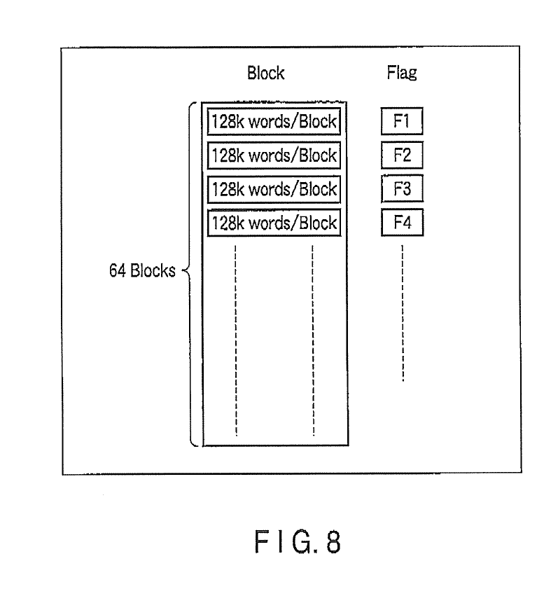

After a nonvolatile semiconductor memory is shipped, however, the characteristics of memory cells normally deteriorate. Therefore, if a block including many low-erase-rate memory cells is found after the first erase operation is performed in the procedure shown in FIG. 7, it is possible to perform control such that, e.g., a flag corresponding to the block is set (changed from “L” to “H”) as shown in FIG. 8, and page erase is performed from the beginning in erase operations from the second time regardless of the procedure shown in FIG. 7.

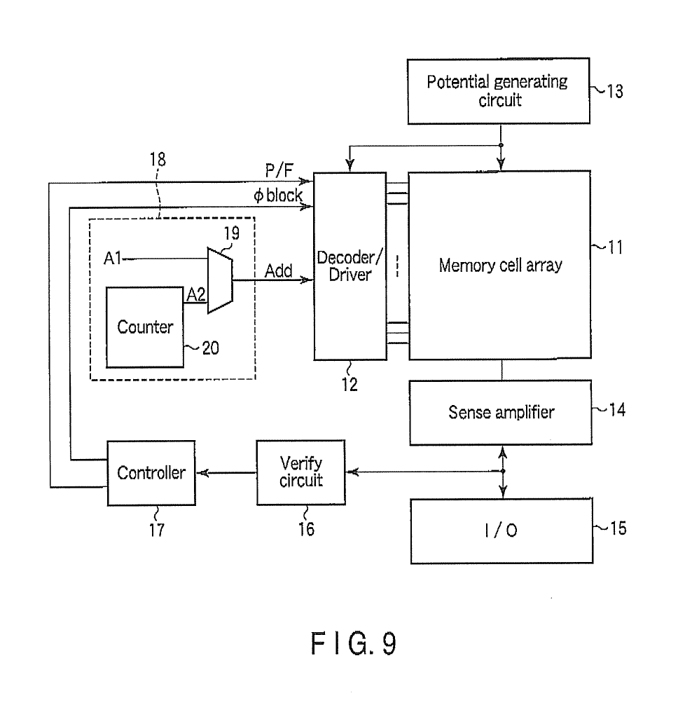

FIG. 9 shows a modification of the nonvolatile semiconductor memory shown in FIG. 1.

In this nonvolatile semiconductor memory shown in FIG. 9, the same reference numerals as in FIG. 1 denote the same elements, and a repetitive explanation will be omitted.

This modification differs from FIG. 1 in that page erase operations (except for a verify operation) for all pages in a selected block are performed in parallel. After that, the verify operation is performed for each page in the same manner as in FIG. 1.

That is, when control signal φ_{block} is “L”, decoder/driver 12 applies erase negative potential (erase potential) −Vera to selected word lines among word lines in a selected block, and applies, e.g., 0 V to unselected word lines. Also, potential generating circuit 13 applies, e.g., 0 V to cell p-well 22 shown in FIG. 3.

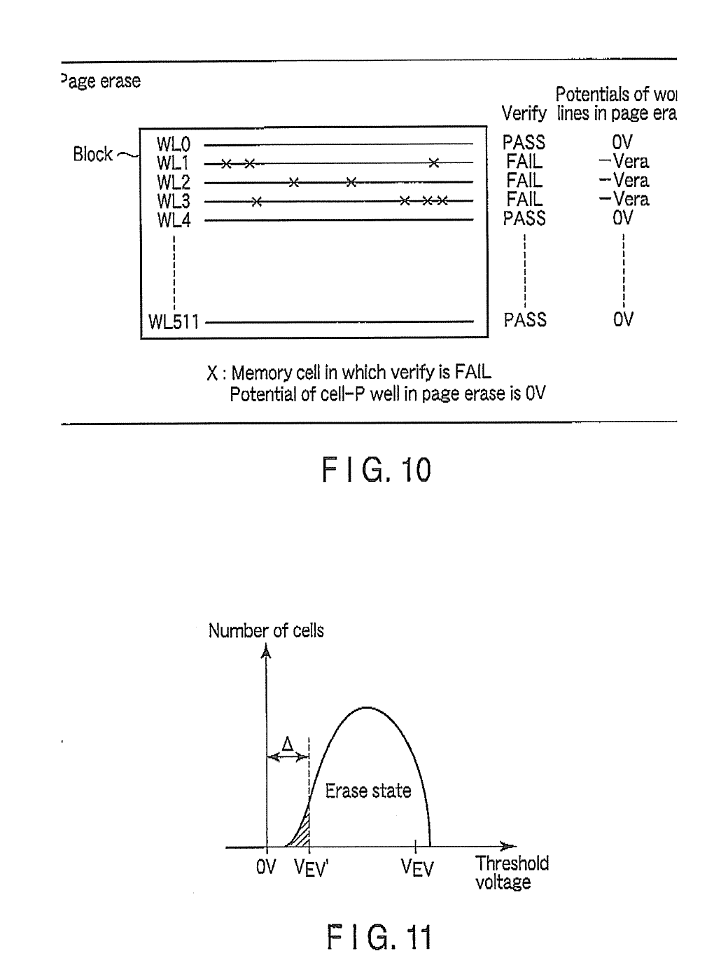

FIG. 10 shows this state. Page erase can be performed by applying −Vera to not all the word lines in the selected block, but only word lines (pages) in which verify has failed.

Note that the word lines in the selected block are separated into selected word lines and unselected word lines by control signal P(pass)/F(fail) from controller 17.

Control signal P/F indicates whether each of the word lines has passed or failed verify. Accordingly, a word line (page) having passed verify is regarded as an unselected word line, and a word line (page) having failed verify is regarded as a selected word line.

This makes it possible to simultaneously perform page erase operations (except for a verify operation) for all the pages in the selected block, and further shorten the erase time.

FIG. 11 is a modification of the provisional erase condition shown in FIG. 7.

The following condition can also be adopted in provisional erase for determining whether to perform block erase or page erase.

When a margin Δ between 0 V and the lower limit of the threshold distribution of an erased memory cell is determined, verify read is performed by erase verify potential V_{EV}′.

If the number of memory cells (a hatched portion) having threshold voltages lower than erase verify potential V_{EV}′ is n or less, the normal erase operation using block erase is performed after that. On the other hand, if the number of memory cells having threshold voltages lower than erase verify potential V_{EV}′ exceeds n, the normal erase operation using page erase is performed after that.

The condition as described above can reduce the number of times of the repetitive operation of erase and write back or eliminate the repetitive operation itself, thereby shortening the erase time. It is also possible to shorten the time during which the voltage stress is applied to a memory cell in the erase operation. This suppresses the characteristic fluctuation (e.g., the delay of erase) of the memory cell.

The embodiment can shorten the erase time of the nonvolatile semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory comprising:
a memory cell array with a block including word lines, and each word line connected to memory cells;
a controller which controls a data erase of the memory cells in the block; and
a verify circuit which verifies whether or not the data erase is completed,
wherein the controller comprises:
being executed a verification by the verify circuit after being executed a first block erase in a predetermined condition,
being executed a second block erase continuously when the number of memory cells which are judged by the verification as a completion of the data erase is n (n is a natural number) or less, and
being executed a page erase continuously when the number of memory cells which are judged by the verification as a completion of the data erase is more than n.

2. The memory of claim 1,
wherein the predetermined condition is a condition in which an erase potential is applied to the memory cells in the block in a term shorter than a term applied the erase potential to the memory cells in the second block erase or the page erase.

3. The memory of claim 1,
wherein the predetermined condition is a condition in which a voltage smaller than a voltage applied between control gates of the memory cells and a well region provided the memory cells in the second block erase or the page erase is applied between the control gates and the well region.

4. The memory of claim 1,
wherein the predetermined condition is a condition in which the completion of the data erase is judged by using an erase verify potential higher than an erase verify potential using the verification after the second block erase or the page erase.

5. The memory of claim 1,
wherein each of the memory cells in the block is allocated in one of threshold distributions higher than 0V.

6. The memory of claim 1,
further comprising a flag corresponding to the block, wherein data showing whether the second block erase executes or the page erase executes after the first block erase is stored in the flag.

7. The memory of claim 1,
wherein the page erase is executed in series to the word lines in the block.

8. The memory of claim 1,
wherein the page erase is executed in parallel to the word lines in the block.

9. The memory of claim 1,
wherein the memory is NOR type flash memory.

10. A nonvolatile semiconductor memory comprising:
a memory cell array with a block including word lines, and each word line connected to memory cells;
a controller which controls a data erase of the memory cells in the block; and
a verify circuit which verifies whether or not the data erase is completed,
wherein the controller comprises:
being executed a verification by the verify circuit using an erase verify potential as a lower limit of a threshold distribution of an erase state after being executed a first block erase,
being executed a second block erase continuously when the number of memory cells having a threshold voltage lower than the erase verify potential by the verification is n (n is a natural number) or less, and
being executed a page erase continuously when the number of memory cells having a threshold voltage lower than the erase verify potential by the verification is more than n.

11. The memory of claim 10,
wherein each of the memory cells in the block is allocated in one of threshold distributions higher than 0 V.

12. The memory of claim 11,
wherein the erase state has a distribution which is the nearest 0 V among the threshold distributions.

13. The memory of claim 10,
further comprising a flag corresponding to the block, wherein data showing whether the second block erase executes or the page erase executes after the first block erase is stored in the flag.

14. The memory of claim 10,
wherein the page erase is executed in series to the word lines in the block.

15. The memory of claim 10,
wherein the page erase is executed in parallel to the word lines in the block.

16. The memory of claim 10,
wherein the memory is NOR type flash memory.

17. The memory of claim 1, further comprising
a potential generating circuit which generates an erase potential for erasing data of the memory cells in the data erase.

18. The memory of claim 1, further comprising
a decoder/driver which selects a selected word line among the word lines in the data erase, wherein the data erase is executed to the memory cells connected to the selected word line.

19. The memory of claim 10, further comprising
a potential generating circuit which generates an erase potential for erasing data of the memory cells in the data erase.

20. The memory of claim 10, further comprising
a decoder/driver which selects a selected word line among the word lines in the data erase, wherein the data erase is executed to the memory cells connected to the selected word line.
